(19) United States
(12) Patent Application Publication
(10) Pub. No.: US 2017/0189815 A1
(43) Pub. Date: Jul. 6, 2017

(54) WEARABLE ACTIVITY TRACKING SYSTEMS AND TECHNOLOGY

(71) Applicant: ACSHUN, INC., Andover, MA (US)

(72) Inventors: Paul Tweedale, Andover, MA (US); Terrence Michael McMahon, Andover, MA (US); Joseph John Ackermann, Vero Beach, FL (US)

(73) Assignee: ACSHUN, INC., Andover, MA (US)

(21) Appl. No.: 15/398,998

(22) Filed: Jan. 5, 2017

Related U.S. Application Data
(60) Provisional application No. 62/281,902, filed on Jan. 22, 2016.
(60) Provisional application No. 62/275,188, filed on Jan. 5, 2016.

(51) Int. Cl. A63F 13/79; A63F 13/58; A63F 13/35

(52) U.S. Cl. CPC A63F 13/79; A63F 13/35; A63F 13/58

(57) ABSTRACT

In some aspects, an activity tracking system is provided, comprising at least one activity tracking device configured to track activity of a user and to generate activity data corresponding to an amount of the activity performed by the user, a server communicatively coupled to the at least one activity tracking device via a network to receive the activity data, the server configured to receive a request for data, determine the data based on the activity data received from the at least one activity tracking device, and provide the data. In some aspects, the request is received from a video game application for attribute data for an avatar of the video game application to influence at least one aspect of the avatar during game play of the video game application. In some aspects, the request is for access data to allow and/or control access to an electronic and/or online activity.

### RELATED APPLICATIONS

This application claims priority under 35 U.S.C. §119(e) to U.S. Provisional Patent Application Ser. No. 62/275,188, filed Jan. 5, 2016 and entitled “Utilization of Activity Metrics Systems and Apparatus” and U.S. Provisional Patent Application Ser. No. 62/281,902 filed Jan. 22, 2016 and entitled “Wearable Activity Tracking Systems and Methods,” each of which is herein incorporated by reference in its entirety.

### BACKGROUND

Wearable technology or “wearables” continue to enjoy a rise in popularity in the consumer marketplace, emerging as a significant contributor to the expanding network of Internet accessible special purpose devices commonly referred to as the Internet-of-Things. Wearable activity tracking devices (also referred to as activity trackers or fitness trackers) have experienced a particular rise in popularity as a consumer product. Wearable activity tracking devices come in a variety of forms and have been used to monitor and track health or fitness related metrics in a number of ways, the most prevalent being step counters or motion trackers configured to measure movement by the wearer. In general, activity tracking devices comprise one or a combination of sensors worn by, or coupled to, a user and configured to measure, monitor and/or track a respective activity and produce a corresponding metric. For example, fitness bands can be worn by the user to facilitate the monitoring and/or tracking of user activity wherever the user is located and whenever the user is in motion.

The market for wearable activity tracking devices has expanded beyond dedicated fitness enthusiasts, extending its reach to more casual exercisers as well as to a wide variety of consumers striving to engage in healthy activity, and/or to those merely intrigued by the latest gadget. As a result, wearable tracking devices are increasingly worn as an accessory both during work outs and throughout the day and are being adopted in increasing numbers.

Activity tracking devices typically come equipped with wireless communication capabilities that allow communication with computing devices accessible via a network (e.g., the Internet). Accordingly, wearable activity tracking devices are often deployed as cloud-based solutions, allowing users to access online and, if so desired, share their activity with other individuals as a way to encourage continued use of the product and, as a consequence, continued beneficial engagement with the corresponding activity. Despite these efforts, conventional strategies to promote continued use of wearable activity tracking devices remain relatively unsuccessful. As a result, once the novelty of the wearable device wears off, many of these devices go unused.

### BRIEF DESCRIPTION OF DRAWINGS

Various aspects and embodiments of the application will be described with reference to the following figures.

FIG. 1 illustrates a system for utilizing activity data received from one or more activity tracking devices, in accordance with some embodiments;

FIG. 2 illustrates a cloud-based system for utilizing activity data received from one or more activity tracking devices, in accordance with some embodiments;

FIG. 3 illustrates a system for providing attribute data based on activity data received from one or more activity tracking devices, in accordance with some embodiments;

FIG. 4 illustrates a method of providing attribute data based on activity data received from one or more activity tracking devices, in accordance with some embodiments;

FIG. 5 illustrates a system for providing access control data based on activity data received from one or more activity tracking devices, in accordance with some embodiments;

FIG. 6 illustrates a method of providing access control data based on activity data received from one or more activity tracking devices, in accordance with some embodiments; and

FIG. 7 illustrates an exemplary computing device suitable for implementing techniques described herein associated with the use of activity data received from one or more activity tracking devices.

### SUMMARY

Some embodiments include an activity tracking system comprising at least one activity tracking device configured to track activity of a user and to generate activity data corresponding to an amount of the activity performed by the user, and at least one server communicatively coupled to the at least one activity tracking device via a network to receive the activity data, the at least server configured to receive a request from a video game application for attribute data for an avatar of the video game application, determine the attribute data including at least one attribute based on the activity data received from the at least one activity tracking device, and provide the attribute data to the video game application to influence at least one aspect of the avatar during game play of the video game application.

Some embodiments include an activity tracking system comprising at least one activity tracking device configured to track activity of a user and to provide activity data corresponding to an amount of the activity performed by the user, at least one server communicatively coupled to the at least one activity tracking device via a network to receive the activity data, the at least server configured to receive a request for access data in connection with an electronic and/or online activity, determine the access data based on the activity data received from the at least one activity tracking device, and provide the access data to allow and/or control access to the electronic and/or online activity.

### DETAILED DESCRIPTION

As discussed above, activity tracking devices (often deployed as a wearable device) are configured to monitor one or more activities engaged in by a user and, in response, provide a corresponding measure of the activity. As such, activity tracking devices can provide health, fitness, physical and/or physiological data associated with user activity. For example, activity tracking devices that track steps taken by a user are widely available as wearable gear (e.g., as wrist or ankle bands) to provide step count data to the wearer. The relative affordability of many types of activity tracking devices has facilitated ready availability of these products to the average consumer. However, ensuring continued use of these products, for the benefit of the consumer and manufacturer alike, remains a significant challenge. In particular, following an initial period of novelty, interest in activity tracking devices often wanes for a significant number of users. Attempts to address this issue, such as allowing users to share fitness metrics with others to provide social motivation or to foster competition (e.g., leaderboards), have been met with limited success. One's own fitness metrics standing alone, much less someone else's, has proven insufficiently engaging to ensure continued use for a significant percentage of consumers of these devices. As such, the health benefits of these devices goes largely unrealized.

The inventors have recognized the need for improved techniques to encourage continued use of activity tracking devices to promote health and fitness, while creating new ways to engage with interactive entertainment and online content. In this respect, the inventors have appreciated that interactive entertainment, and more particularly video games, present an attractive means to promote and motivate utilization of activity tracking devices. To this end, the inventors have developed techniques that facilitate linking real world activity of a user to the behavior of avatars within the context of game play. According to some embodiments, an activity tracking system is provided in which activity data, captured by one or more activity tracking devices monitoring user's real world activity, is used to modify at least one attribute of an avatar of a video game. As a result, aspects of the behavior of the avatar may be controlled, governed and/or influenced by the real world activity of the user.

The inventors have further recognized that access to certain electronic or online activities, such as interactive entertainment (e.g., video games), online browsing, or engaging with other online content or activities, may be utilized to promote or otherwise encourage increased beneficial use of activity tracking devices. In this respect, the inventors have developed techniques by which activity data captured by one or more activity tracking devices in monitoring real world activity of a user is used to control access to one or more restricted activities (e.g., playing video games, viewing online content and/or engaging in other electronic or online activities). For example, the type, quantity and/or quality of activity engaged in by a user, as captured by one or more activity tracking devices, may be used to control the amount of time that a user is allowed access to restricted activity. Thus, a user may play video games, view online content, or otherwise engage in electronic or online activity in proportion to the user's real world activity. In this respect, the activity tracking system may be used as a measure of access control, for example, parental control over their children's access to certain designated restricted activities. Thus, balance may be achieved between time spent engaging in real world and virtual activity by making the latter dependent on the former. Alternatively, or in addition to, these same techniques may be employed as self-imposed restrictions to regulate one's own online activities as a reward mechanism to encourage and motivate users to engage in healthy activity.

The inventors have further appreciated that monetary incentives can be used to encourage continued use of activity tracking devices and, as a result, continued participation in health or fitness related activities, either individually or as part of a group. According to some embodiments, an individual's activity data may be transformed into activity capital or activity points that can be used in a number of ways, for example, redeemed by the individual, or used collectively by a group, to receive discounts or other pecuniary benefits. For example, an individual's activity data accrued from engaging in activity captured by one or more activity tracking devices may be used to receive a discount from participating businesses (e.g., a discount on a gym membership). Individuals may form a group based on existing relationships, connections or interests (e.g., employees of a company) and aggregate activity data (e.g., captured by a wearable device) accrued by the individual activity efforts of members of the group can be used to obtain a discount or a monetary reward (e.g., a reduction in health care premiums for the company based on the level of participation and the resulting amount of activity data accumulated therefrom). As another example, organizations can sponsor drives or competitions between groups, providing donations to charitable causes in proportion to accumulated activity data, individual or aggregate, represented by total activity capital or activity points generated based on the type, quantity and/or quality of activity performed by members of the group. Activity capital or points based on the accumulated activity of individuals and/or individuals in a group, as captured by respective activity tracking devices, may be used in other ways, as the aspects are not limited in this respect.

The inventors have further appreciated that continued use of activity tracking devices (e.g., a wearable device such as a wrist or ankle band), and the resulting continued involvement in healthy and beneficial activity, may be encouraged by the development of an online activity presence for users. According to some embodiments, a cloud-based activity tracking system is provided, wherein users create an online activity profile associated with an activity account for the user. The user's activity account stores and manages the user's activity data received from any associated (e.g., linked) activity tracking device. The activity tracking system may then utilize the activity data in accordance with any of the techniques discussed above and described in further detail below. Additionally, a user's activity profile can be utilized in other ways such as in online virtual or simulated competitions between teams based on their activity profiles. For example, users may be drafted or otherwise invited to join a team (or a user can draft, invite or recruit other users to join a team) in a simulated competition where the users' activity profiles compete against one another in the simulated competition. The amount of activity engaged in the by the user then corresponds to how well the user will perform in the simulated competition, and the user's value or worth in this respect has a corresponding connection to the user's real world activity. According to some embodiments, this activity value or worth (e.g., as characterized by an activity capital measure or activity points that corresponds to the user's real world activity as recorded by the user's activity tracking device(s)), may be monetized, for example, as a charge to other users for joining other teams or groups in online activities or simulations.

As used herein, activity refers to any act, behavior and/or endeavor, whether active or passive, engaged in or performed by a user that can be monitored and/or tracked. Specifically, activity is not limited to actions involving physical movement or exercise (e.g., walking, running, calisthenics, cycling, swimming or other cardiovascular and/or strength training activities), but includes passive activity such as sleep, meditation, or in some circumstances, reading or other mental activities (e.g., an electronic book may monitor how long a user engages in reading to provide corresponding activity data reflective of reading time). As such, some activity tracking devices may monitor physical activity (e.g., movement), while other activity tracking devices may monitor passive activity (e.g., sleep, mediation, etc.). Moreover, it should be appreciated that an activity tracking device need not measure any particular activity, but may instead measure one or more physical or physiological properties indicative of activity generally, whether it be active or passive, physical or mental. For example, in addition to activity tracking devices that measure specific activity (e.g., step counters), an activity tracking device may be, or may include, any one or combination of a heart rate monitor, a device that measures brain activity (e.g., to measure sleep stages or meditative states), a galvanic skin response sensor (e.g., to measure perspiration), blood pressure monitor, respiratory monitor, etc. Any metric of one or more activities or measure of one or more physical and/or physiological parameters indicative of activity may provide suitable activity data for use with techniques described herein.

Following below are more detailed descriptions of various concepts related to, and embodiments of, wearable activity tracking systems and techniques for utilizing activity data obtained therefrom in any one or combination of applications described herein. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

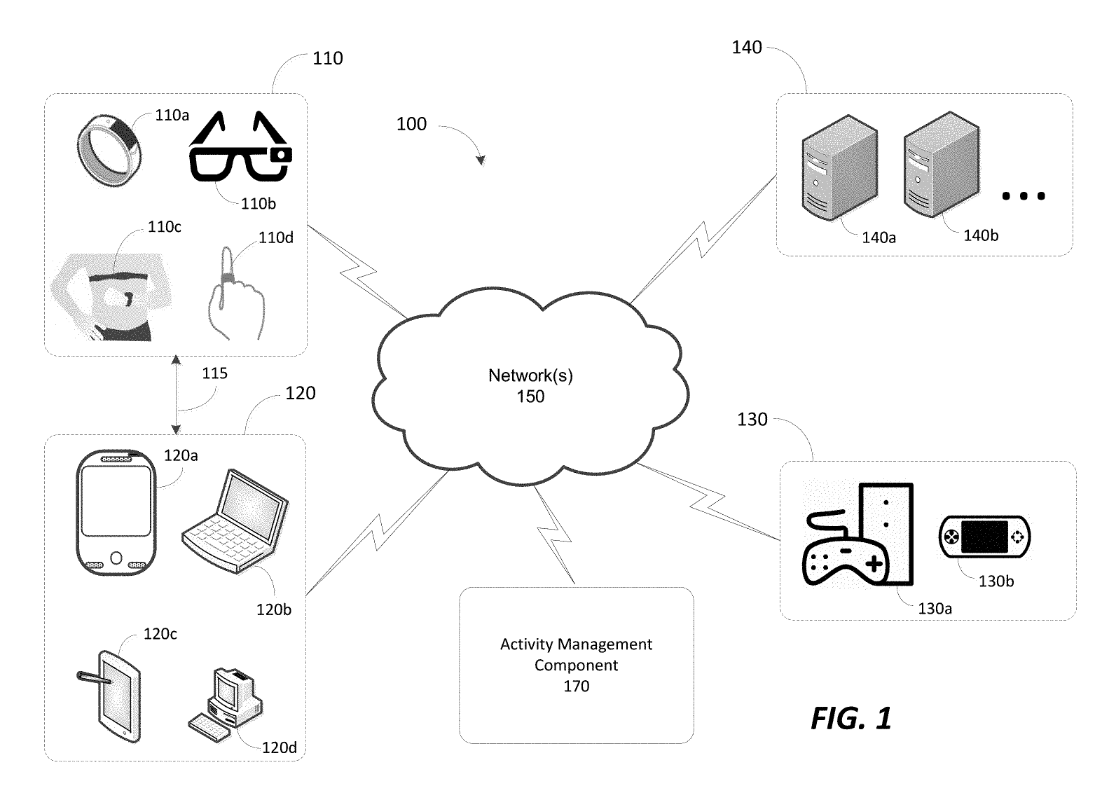

FIG. 1 illustrates an exemplary activity tracking system, in accordance with some embodiments. System 100 may include one or more activity tracking devices 110, a number of exemplary wearable activity tracking devices of which are illustrated. For example, system 100 may include any one or combination of wrist or ankle mounted activity tracking devices 110a, visor 110b, body strap 110c, ring 110d, or any other suitable activity tracking device configured to monitor one or more activities to produce corresponding activity data. It should be appreciated that activity tracking devices may be provided in any number of other wearable configurations, such as arm bands, head bands, sensors integrated with (or attachable to) clothing or apparel, and/or accessories such as necklaces, earrings, belts, etc.

A wearable activity tracking device typically includes a communications interface that allows the wearable device to communicate with other computing devices, either directly (e.g., via a wire connection protocol such as USB and/or a wireless protocol such as Bluetooth) or via one or more networks (e.g., via the Internet). For example, activity tracking device(s) 110 may include a wireless transceiver capable of communicating with one or more cellular networks. Alternatively, or in addition to, activity tracking device(s) 110 may include a wireless transceiver capable of communicating with one or more other networks or external devices. For example, activity tracking device(s) 110 may include a wireless transceiver configured to communicate via the IEEE 802.11 standard (Wi-Fi) to connect to network access points coupled to one or more networks (e.g., local area networks (LANs), wide area networks (WANs) such as the internet, etc.). In this respect, network 150 may be any one or combination of networks interconnecting various network accessible devices including, but not limited to, any one or combination of LANs, WANs, the internet, private networks, personal networks, etc.

In addition, activity tracking device 110 may include communication link 115 allowing for “direct” wireless communication (e.g., via a Bluetooth® transceiver to connect to a Bluetooth® compatible computing device) and/or may include one or more wired interfaces (e.g., USB, Firewire, etc.) that allow the respective devices to communicate with another computing device via a wired connection. In this manner, the communication path between exemplary components of an activity tracking system, and the source and destination for data exchange, can take on many different configurations, allowing for the activity tracking system to be synced and/or updated via server initiated, user initiated and/or activity tracking device initiated communication. Communication link 115 also permits communication both when the activity tracking device and/or personal computing device is connected to network 150, or when one or both components are not presently connected to the network. As used herein, the term “communicatively coupled” refers to connectivity achieved via any of the above types of connections (e.g., device-to-device communications and/or communications via a network) that allows for information or data exchange between computing devices (e.g., an activity tracking device 110 and one or more other computing devices 120).

Activity tracking device(s) 110 may include one or more sensors that monitor any one or combination of activities. For example, activity tracking device(s) 110 may include an odometry device configured to monitor user locomotion to obtain activity data indicative of the distance traveled by the user using human locomotion. According to some embodiments, an odometry device includes one or more inertial sensors (e.g., accelerometers, gyroscopes, etc.) configured to sense accelerative movement, for example, steps taken by the wearer. Such step counters are common and readily available consumer activity tracking devices, providing activity data in the form of a step count and/or as a distance traveled by the user derived from the step count (e.g., using an average stride length or an actual stride length of the individual obtained as an input by the user or computed using other means). Inertial sensors can also be used to track other activity, for example, general accelerative movement resulting from various cardiovascular activities to provide activity data representative of the amount of movement that the wearer has engaged in.

Alternatively, or in addition to inertial sensors, an activity tracking device may include positioning technology, such as global positioning system (GPS) technology, cellular location technology, etc., capable of determining the distance traveled by a user wearing or holding the activity tracking device. These technologies can be used independently, or can be used in combination, to provide additional activity, such as locomotion rate. Rate information can be used to determine an exertion metric, estimate the number of calories burned, estimate the average stride length of the particular user to improve subsequent distance calculations (e.g., when, for example, GPS or cellular technology is not available), etc. An activity tracking device may be, or may include, other technology to monitor and track human locomotion, as the aspects are not limited in this respect.

Furthermore, activity tracking device(s) 110 may include any one or combination of sensors to measure physiological parameter(s) of the wearer, such as cardiovascular data (e.g., heart rate, blood pressure, etc.), galvanic skin response sensors (e.g., to monitor perspiration levels to derive exertion metrics), brain activity sensors (e.g., electrical or magnetic sensors configured to measure neural activity in the brain to, for example, monitor sleep, brain states achieved via mediation, or data regarding other mental or physical activities), etc. Physiological sensors may be used alone or in any combination to produce activity data representative of activity (whether mental or physical, passive or active) engaged in by the wearer, providing health or fitness metrics for the user that can be employed to provide any of the activity-based services described herein. As another example, activity tracking device(s) 110 may include a sleep tracker that records the amount of sleep a user gets and/or durations spent in the various sleep stages (e.g., the various rapid eye movement (REM) and non-REM stages). Sleep is a significant contributor to mental as well as physical health and presents another mechanism to produce activity data that can be used as a health metric employed by techniques described herein.

It should be appreciated that an activity tracking device 110 may include any one or combination of sensors, measurement devices, or other technologies capable of tracking activity, as the techniques described herein are not limited for use with any particular type of activity tracking device or any particular type of activity. As discussed above, activity tracking devices configured to monitor more than one type of activity may use the different metrics obtained together to provide a richer set of activity data.

According to some embodiments, one or more of activity tracking devices 110 are implemented as a cloud-based solution. In a cloud-based deployment, a network-capable activity tracking device is configured to communicate with one or more servers 140 connected to network 150 (e.g., the Internet). When connected, an activity tracking device may transmit the activity data obtained, status information or any other desired data to a respective server 140. In addition, server 140 may transmit information or data to the respective activity tracking device, such as updated software, profile information of the user, or other data useful to the operation of the activity tracking device and/or information for display to the user via the activity tracking device. In this way, an activity tracking device can sync with its corresponding server and appropriate data can be exchanged.

Servers 140 may be configured to store and manage the data for users of a respective activity tracking system. For example, a user may have an account associated with the activity tracking system being utilized. The account may include information about the user and the user's specific instantiation of the activity tracking system. For example, the account may include a user profile having user login/password information, demographic information, user preferences, associated applications, activity tracking devices, further linked accounts, etc. In this respect, servers 140 may be configured to communicate with one or more personal computing devices 120 (e.g., smart phone 120a, tablet 120b, laptop 120c, personal computer 120d, or other suitable personal computing device) via one or any combination of a website hosted by one or more servers 140, via an application installed on the personal computing device, via an app downloaded on the personal computing device, or any other suitable means for communicating between server(s) 140 and personal computing device(s) 120.

It should be appreciated that, in some embodiments, a personal computing device 120 may also function as an activity tracking device 110. For example, a smart phone may include one or more sensors configured to monitor and provide activity data, for example, odometry data, physiological data or any one or combination of activity data described herein. In this manner, a smartphone may operate both as an activity tracking device and a personal computing device in the activity tracking system. In this respect, the activity tracking device and the personal computing device are communicatively coupled via the internal communication capabilities (e.g., internal bus architecture between processors, sensors, memory, etc.) of the personal computing device.

By way of illustration, an exemplary activity tracking system may comprise an activity tracking device 110 having an associated server 140 connected to the Internet to provide a cloud-based solution. An app may be available for download on a smart phone 120a that allows the user to view and interact with the activity data obtained by the activity tracking device 110. For example, the activity tracking device may include one or more sensors (e.g., inertial sensors such as accelerometers, gyroscopes, etc.) configured to track the number of steps the wearer takes. This activity data (step count) may be provided to a server 140 and/or a smart phone 120 for storing in association with the user's account, for viewing by the user via the activity tracking device, the personal computing device and/or via an associated website. Activity data may additionally be shared with other online accounts such as facebook, twitter or other social or networking online sites.

As discussed above, conventional activity tracking systems currently provide limited engagement and utility with respect to the activity data provided by the system (e.g., sharing raw activity data online, leaderboards, etc.). As a result, users often lose interest in the activity tracking device and their use significantly declines along with the healthful benefits as a consequence. The inventors have developed activity tracking systems that utilize activity data in innovative ways to promote, encourage, motivate and/or incentivize continued use of activity tracking device(s) and ongoing and increased engagement with the respective activities being tracked. In this respect, system 100 includes an activity management component 170 configured to obtain activity data from one or more activity tracking devices and provide activity services designed to promote continued use of the system, a number of specific examples of which are described in further detail below. Activity management component 170 may be part of one or more servers 140 or may be a separate component (e.g., provided by one or more others servers connected to network 150).

According to some embodiments, activity management component 170 receives activity data from one or more activity tracking devices 110 and produces attribute data that can be used to adjust, modify, govern or influence behavior, performance or appearance of an avatar in the context separate interactive entertainment such as a video game (e.g., one or more properties, characteristics or features of the avatar). For example, activity management component 170 may be configured to transform activity data from a user's activity tracking device(s) to attribute data that improves the performance of an avatar in the context of game play. In this manner, a user's real world activity can be utilized to influence the behavior or performance (or appearance) of one or more avatars in a virtual world, linking the real world activity of the user to the user's gameplay experience. In this respect, system 100 may include one or more game computing devices 130, for example, game console 130a, handheld game device 130b, etc. As discussed in further detail below, activity management component 170 may be separate from game device(s) 130 and accessible via a network (e.g., network 150), or may be integrated (partially or entirely) with game device(s) 130 itself, as the aspects are not limited to any particular limitation.

According to some embodiments, activity management component 170 receives activity data from one or more activity tracking devices 110 and produces access control data that can be used to allow, restrict and/or limit a user's access to restricted activities. The access control data may be used, for example, as a parental control mechanism requiring users to engage in healthy real world activity in exchange for the privilege of engaging in a restricted activity (e.g., playing a video game, accessing social network websites, viewing online content, etc.). Access control techniques may be utilized to encourage and motivate real world activities that have health benefits, contributing to solutions to health issues arising from increasingly sedentary lifestyles. Further details of exemplary access control techniques in accordance with some embodiments are described below.

According to some embodiments, activity management component 170 receives activity data from one or more activity tracking devices 110 and produces activity capital or activity points in proportion to the type, quantity, quality, regularity and/or recentness of the activity resulting in the respective activity data. Activity capital or points can be utilized in a number of ways, for example, to obtain discounts or rewards, for use in virtual or fantasy competitions and/or to receive other pecuniary benefit, some examples of which are described in further detail below. Activity management component 170 may utilize activity data in other ways, as the aspects are not limited in this respect.

Activity management components described herein (e.g., activity management component 170) may be implemented in any suitable way and is capable of being realized in numerous configurations. For example, an activity management component may be implemented, entirely or partially, by any one or combination of computing devices, including by any one or combination of activity tracking devices 110, personal computing devices 120, gaming consoles 130 and/or servers 140. Aspects of an activity management component may be integrated on a single computing device (e.g., a network accessible server 140, personal computing device 120 and/or game device 130), or may be distributed across multiple computing devices. For example, an activity management component may be implemented by a network computing device (e.g., a network server) or distributed over multiple network computing devices, and its functionality accessed via a network (e.g., network 150).

Alternatively, or in addition to, aspects of activity management component may be hosted by, or otherwise resident on, one or more personal computing devices 120, either as a standalone implementation, or in communication with aspects of activity management component 170 implemented elsewhere (e.g., in the cloud). Similarly, aspects of an activity management component may be hosted by, or otherwise resident on or implemented by, one or more activity tracking device 110, either as standalone functionality or in communication with aspects of activity management component 170 implemented via the cloud or accessible via device-to-device communication. As such, unless otherwise specified, processing described as being performed by an activity management component, server, service or engine, refers to processing performed by any one or combination of the constituent components, operating alone or in concert with other constituent components, whether implemented on a single computing device or distributed over multiple computing devices.

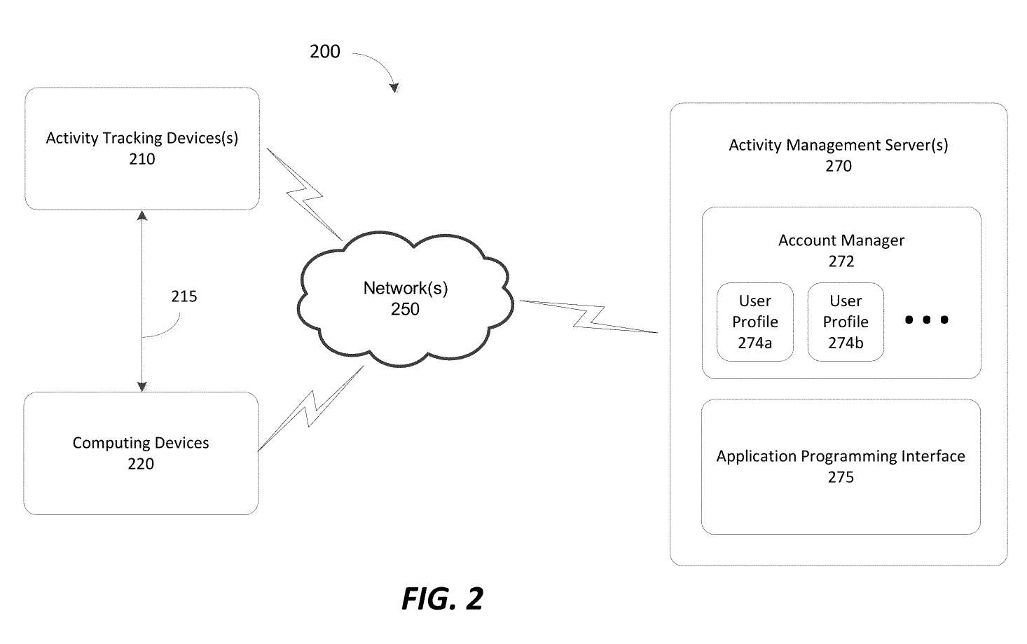

According to some embodiments, an activity management component is implemented as a cloud-based solution where activity services are provided via or one or more servers accessible via a network (e.g., the Internet). FIG. 2 illustrates an exemplary cloud-based activity management system, in accordance with some embodiments. System 200 comprises one or more activity tracking device 210, which may include any one or combination of activity tracking devices described herein (e.g., any one or combination of activity tracking devices 110 discussed in connection with FIG. 1). System 200 further comprises one or more computing devices 220, which may include any one or combination of personal computing devices, gaming consoles or other suitable computing devices (e.g., any one or combination of personal computing devices 120 and/or game devices 130 discussed in connection with FIG. 1). In the exemplary system illustrated in FIG. 2, various techniques described herein are implemented via activity management server 270. Activity management server 270 may be a single server or may include multiple servers, either located at a particular geographic location or distributed geographically in any suitable manner.

Activity management server 270 allows users to create or set up an account, via account manager 272, that can be utilized, linked or otherwise accessed by activity tracking device(s) 210 (or servers associated with the activity tracking devices), computing device(s) 220 or applications executing thereon, or other devices that can access the cloud. Each account may include a user profile (e.g., user profile 274a, 274b, etc.) that may store, among other data, information about the user, activity tracking devices used by the user, user preferences, links to other accounts and any activity data captured by associated activity tracking device(s) belonging to the respective user associated with the activity account. Activity management server 270 may receive activity data from the various activity tracking devices either directly via network 250, or via another server (e.g., a third party server associated with respective activity tracking device products) via network 250. In this way, activity management server 270 retains and manages activity data corresponding to real world activity performed or completed by the respective user.

A user may access their account, for example, via a login/password or other suitable method, to view their activity data and/or data derived therefrom (e.g., attribute data, access control data accrued, activity capital or points accumulated), change settings or preferences, add links to other users, user accounts, or other personal accounts (e.g., facebook, twitter, other fitness accounts, etc.), add features, or otherwise utilize there activity account, some examples of which are described in further detail below. Access to the account may be provided using any one or combination of interfaces including, but not limited to, a website, an app downloaded on, for example, a smartphone or a tablet device, and/or via an application hosted by any suitable computing device (e.g., any suitable personal computing or game device), as discussed in further detail below. In this manner, activity management server 270 maintains an online presence for the user in connection with their real world activity.

A user's activity profile can represent the user's activity value, for example, by storing activity capital or activity points derived from the user's real world activity that can be beneficially exploited by users in a number of different ways, many of which are designed to encourage users to live a more active and healthy lifestyle to maximize the benefits of their activity profiles. As discussed in further detail below, some aspects are directed to providing a platform that allows other applications to utilize and build upon the accumulated activity data recorded by activity tracking devices associated with respective users. Techniques described herein may also provide a mechanism to allow specifics of the user's activity data to remain private, while allowing aspects to be shared to capitalize on the user's real world activity. In this respect, raw activity data received from activity tracking devices may, according to some embodiments, be held securely and information derived therefrom may be made accessible to facilitate various activity-based services, some exemplary services of which are described herein.

Activity management server 270 may also include application programming interface (API) 275 exposing functionality that allows external computing devices to access activity data or information derived therefrom (e.g., attribute data, access control data, activity capital or points, etc.). API 275 may include any type of interface that allows programmatic access to data, e.g., via applications, apps, scripts, queries, requests, etc. According to some embodiments, API 275 comprises one or more libraries of functions that can be called programmatically from any suitable computing device and/or applications executing thereon to access functionality exposed by activity management server 270. API 275 may allow application developers to integrate and utilize users' activity profiles in the context of the application. In this respect, activity management server 270 can operate as an activity platform from which further applications and systems can be developed, some examples of which are also described in further detail below.

Activity tracking systems described herein can communicatively couple, via an activity management component, to a virtually limitless variety of heterogeneous activity tracking devices, providing for a complete solution not presently available. The inventors have developed techniques of integrating activity data from multiple and/or heterogeneous activity tracking devices to provide consolidated activity information that can be used in other contexts. Not only do conventional activity tracking systems provide limited functionality with respect to obtained activity data, conventional systems merely record activity data from an associated activity tracking device, which may represent only fraction of the activity engaged in by a user. Aspects of the activity tracking systems described herein provide a platform capable of collecting, managing and, in some embodiments, integrating all activity data captured by any activity tracking device of respective users, independent of number and type. Thus, regardless of the type or number of activity tracking devices owned, users can have all of their activity data managed under a single activity account, and the resulting heterogeneous activity data can be utilized in new ways developed to encourage continued use of the activity tracking devices, some examples of which are described in further detail below.

According to some embodiments, a user's activity account may allow a user to manage privacy of his/her activity data. For example, a user may desire the raw activity data to be remain private (e.g., the number steps taken, heart rate data, the amount of sleep obtained, etc.) while still enjoying aspects of the techniques described herein. For example, a user may desire to utilize attribute data to influence game play (e.g., as discussed in further detail below) while retaining privacy over the specific activity engaged in, how much activity was completed, and when it was performed. A user account may allow the user to customize the privacy settings associated with the user's activity data so that only desired information is shared. This provides another beneficial way in which users can manage, utilize and employ their real world activity.

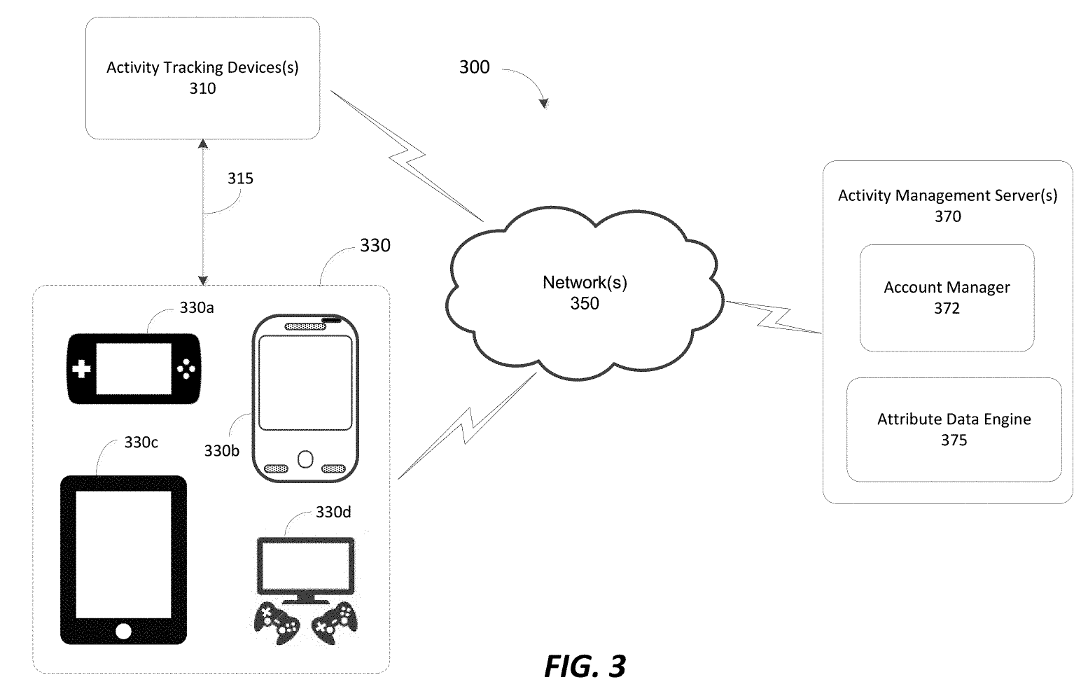

FIG. 3 illustrates a system configured to utilize activity data to control the behavior of one or more avatars in a video game, role playing game, or other interactive entertainment, in accordance with some embodiments. Video games enjoy widespread popularity and have emerged as both a significant industry sector and as a driver of technology. Yet, engaging in video games is generally sedentary and may, in some cases, interfere with users engaging in healthier activity. The inventors have recognized that utilizing activity data from activity tracking devices in the context of game play may motivate users to engage in healthy activity to improve their experience (e.g., by improving game performance) during the course of game play. As a result, a better balance between healthy and sedentary activities can be achieved.

Many video games involve the control of an avatar or multiple avatars to achieve an objective in the context of the game. As used herein, an avatar refers to an electronic representation (e.g., typically via graphics) or presence (e.g., the implied presence in many first-person perspective games) of a person, character or object that is controlled in a video game, used in a role playing game, or otherwise utilized in interactive entertainment. Non-limiting examples of avatars include, but are not limited to, players in a sports video game, characters in an adventure game, objects in a strategy, combat or war game, a car in a racing game, etc.

Avatars typically have a set of properties, features and/or characteristics (referred herein collectively as attributes) that determine their behavior in the context of the corresponding game. For example, an avatar in a sports or adventure game may have attributes including strength, accuracy, endurance, effectiveness, agility, constitution, experience, appearance and/or any other attribute that governs how the avatar will perform, behave or react when the game is played. It should be appreciated that because avatars may represent biological, non-biological and entirely fantastical objects, attributes governing an avatar's behavior are virtually without limit and will depend on the design, narrative and/or objective of the particular video game.

In conventional games, an avatar's attributes are influenced by the actions and events that transpire in the virtual world of the game, and are generally confined in this respect. Avatar attributes may change based on experiences, items encountered or other phenomena within the context of the game, but are generally not impacted by the real world. While some avatars are modeled with attributes that reflect characteristics of real world counterparts (e.g., sports figures in sports video games may be modeled, at least in part, on their real world counterparts), the user's real world activity does not impact or otherwise influence the game. As discussed above, the inventors have developed techniques that facilitate linking real world activity of the user to the behavior, performance and/or appearance of avatars in a game. According to some embodiments, activity data captured by one or more activity tracking devices corresponding to activity of a user, is transformed to attribute data corresponding to at least one attribute of an avatar in a game. As a result, aspects of the behavior, performance or appearance of the avatar may be controlled, governed and/or influenced by the real world activity of the user.

Referring again to FIG. 3, a number of exemplary gaming devices suitable for use with the techniques described herein are illustrated. In particular, handheld gaming device 330a, smartphone 330b, tablet computer 330c, and game console 330d are illustrative of the types of devices on which games are commonly played. In addition, virtual reality helmets, personal computers, workstations and other computing devices can also be used to play or participate in games or other interactive entertainments. Most commonly, suitable gaming devices will be capable of connecting to a network (e.g., network 350), and therefore are capable of accessing services provided by activity management server 370, particularly with respect to obtaining attribute data, derived by attribute data engine 375 from a user's activity as captured by one or more activity tracking devices 310. However, a game device need not have necessarily have access to a network to utilize these techniques. For example, aspects of activity management server 370 (e.g., attribute data engine 375) may be provided on the gaming device itself, which may receive activity data from one or more activity tracking devices 310 via a direct wired or wireless connection, rather than utilizing the network. According to some embodiments, a gaming device is configured both to operate with and without a connection to network 350, as the aspects are not limited in this respect.

Activity management server 370 (which may be implemented in any of the ways discussed above in connection with FIGS. 1 and 2) may include any one or combination of computing devices, either provided locally or distributed geographically, accessible via network 350 (e.g., the Internet). Activity management server 370 is configured to manage activity data received from activity tracking device(s) 310 and to manage user profiles associated with user accounts established with the system (e.g., as discussed above in connection with FIG. 2). Activity management server 370 includes attribute data engine 375 configured to service requests for attribute data configured for use in influencing the behavior or performance of an avatar in the context of game play. According to some embodiments, attribute data engine 375 is implemented as an API similar to that discussed in connection with FIG. 2, allowing connected devices to access functionality of activity management server 370. However, attribute data engine may be implemented in other ways suitable for servicing requests for attribute data based on activity data received from activity tracking devices(s) 310, as the aspects are not limited in this respect.

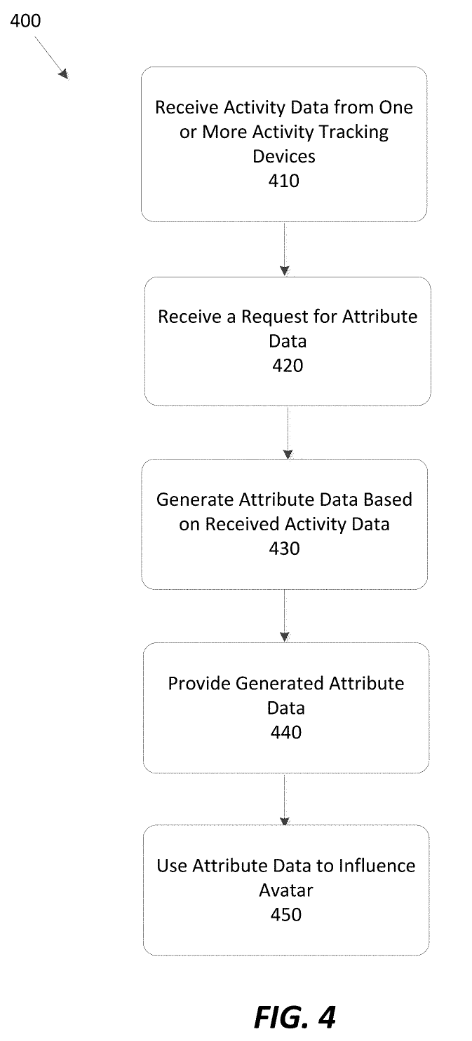

FIG. 4 illustrates a method of using activity data captured by one or more activity tracking devices in the course of monitoring activity engaged in by a user to produce attribute data that can be used, for example, as a basis for at least one attribute of one or more avatars, in accordance with some embodiments. For example, method 400 may be implemented or performed by the exemplary systems described in connection with FIGS. 1-3. In act 410, activity data corresponding to activity engaged in by a user, as captured by one or more activity tracking devices, is obtained. For example, any type of activity data captured by any number of activity tracking devices may be obtained, including, but not limited to, the exemplary activity tracking devices and associated activity data described in the foregoing. The activity data may be obtained by any computing device communicatively connected to respective activity tracking devices, either via device-to-device communication or via a network.

In act 420, a request for attribute data is received. According to some embodiments, a video game executing on a gaming device may request attribute data that can be used as, or as a basis for, at least one attribute associated with one or more avatars of the video game. The request for attribute data may include the type of attribute for which data is being requested (or this information may be implied by the particular function called in implementations having an API to service such requests), and may additionally include an identification of the user so that the attribute data that is provided corresponds to the real world activity of the user playing the video game. According to some embodiments, the request for attribute data may specify an interval of time of interest with respect to the activity data. For example, some applications may be interested in very recent activity while other applications may be interested in activity over longer intervals. Thus, the request may specify that the attribute data provided correspond to activity data resulting from activity engaged in within the specified interval (e.g., within the last three days, week, month, etc.). In this way, an application can choose how important the recentness of the activity is to controlling respective avatars. Additionally, different time intervals may be specified for different attributes to customize and/or tailor the manner in which activity data influences respective avatars in the context of the game. According to some embodiments, a request for attribute data may also include a reference value that provides a level of a corresponding activity relative to which the attribute data should be derived. For example, some applications may set a reference value of 10,000 steps, 20,000 steps, etc. against which attribute data may be computed. For example, the same quantity of activity data may be transformed differently based on the reference value (e.g., attribute data values may be less for applications submitting higher reference values). In this manner, applications can have a measure of control and customization with regard to how rigorous and demanding it is on users from an activity perspective.

As discussed above, a component providing attribute data (e.g., attribute data engine 375) may be hosted by the same device as the gaming application or may be hosted remotely and accessible over a network. Additionally, the attribute data engine may be integrated (partially or entirely) in the gaming application itself, or may be provided as a separate network accessible component. In this respect, the request for attribute data may be, or may involve, a request internal to the gaming application or may be, or may involve, an external request to a separate component on the same computing device or to a separate computing device accessible via a network, or may involve device-to-device connection. When attribute data engine is implemented, at least in part, on or by the game device, the game device may be communicatively coupled so as to receive activity data via respective activity tracking devices, either via a direct connection thereto or via a network connection.

In act 430, attribute data is generated based on activity data obtained from the one or more activity tracking devices (e.g., obtained in the performance of act 410). The attribute data may be computed in a number of suitable ways and may depend on the type or types of activity data recorded for a given user. Activity data may be converted to attribute data based on the quantity, quality, consistency and/or recentness of the activity. For example, step counter activity data may be converted to attribute data having values proportional to the number of steps, the rate at which the steps were taken and/or how recently and/or how consistently the user engaged in the stepping activity. Heart rate data may be converted to attribute data based on how long the user maintained an elevated heart and by what amount the heart rate was elevated over resting. Other activities can be similarly transformed to attribute data based on type, quantity, quality and/or recentness.

According to some embodiments, different attributes may focus or may be derived entirely from different aspects of the activity data. For example, an endurance attribute may focus on consistency of the activity, a strength attribute may focus on the quantity of the activity, an accuracy or speed attribute may focus on the quality of the activity, etc. The recentness of the activity may be used to scale the attribute data so that the more recent the activity, the more impact it has on the attribute of the avatar. However, such variation among attributes need not be utilized and attribute data may be computed in the same or similar manner independent of the nature of the attribute. It should be appreciated that attribute data may be derived using any one or combination of aspects of the corresponding activity data, as the aspects are not limited in this respect.

In act 440, the attribute data generated in act 430 is provided to the requesting video game for use in the context of game play. As discussed above, the attribute data engine servicing requests may be located on the same device as the gaming application or may be located remotely and accessible over a network. Additionally, the attribute data engine may be integrated in the gaming application itself or may be a separate component. In this respect, providing the attribute data may involve providing the attribute data internal to the gaming application or may involve providing attribute data to a gaming application located on the same computing device, or may involve providing attribute data over a network from a computing device accessible via the network.

In act 450, the attribute data is utilized to modify at least one attribute of an avatar in the game to govern or influence the performance, behavior and/or appearance of the avatar in the context of game play. As one non-limiting example, a sports video game may utilize attribute data for a player avatar for use in influencing the performance of the player avatar in the context of playing the video game. For example, the attribute data may be used to influence the throwing accuracy of a quarterback, speed and/or agility of a running back, catching effectiveness of a receiver and/or strength of a linebacker in a game of football, shooting accuracy for a basketball player, skating speed and/or checking strength for a hockey player, pitching, batting and/or fielding abilities for a baseball player, etc. In this respect, attribute data may be obtained and used to influence performance of a player avatar in any desired manner and the manner in which attribute data is utilized will depend on the design of the game and/or type of athletic contest that the game simulates.

As another non-limiting implementation, an adventure game may request attribute data for a character avatar for use in influencing the behavior or appearance of the character avatar in the context of the adventure. For example, the adventure game may request attribute data to influence a character's offensive or defensive effectiveness in combat, the amount of damage the character can survive, the endurance of the character in battle, or to influence any other attribute having a bearing on the character's efficacy in the context of game play. Attribute data may also be used to affect the appearance of the avatar. For example, when attribute data reflects relatively large and/or recent quantities of real world activity by the user, the appearance of the avatar may be presented to visually indicate that the player will perform robustly or effectively in the context of game play.

As another non-limiting example, attribute data may govern or influence the performance of machines, equipment, or other objects in the context of gameplay. For example, attribute data may be requested to impact the effectiveness of a weapon (e.g., the amount of damage a weapon can inflict, firing power, amount of ammunition available to a weapon, etc.). Attribute data may be used to dictate maximum speed, acceleration, ease of handling, fuel levels, etc. of a vehicle, for example, in the context of a racing game or a military strategy or war game. It should be appreciated that attribute data can be employed as any suitable metric that can be used to govern or influence the behavior, performance and/or appearance of a game avatar, as the aspects are not limited in this respect.

Provided below are a number of non-limiting examples of producing attribute data for an avatar from activity data in the context of step count. However, it should be appreciated that the techniques described below may be applied to any type of activity data and are not limited for use with step count or any other particular type of activity data. Likewise, the general techniques applied to the example attributes of speed, strength, accuracy and endurance discussed below can be applied to any desired attribute in a manner that reflects the attribute. Furthermore, it should be appreciated that the following techniques are illustrative and not limiting, as attribute data may be computed in other ways, either from step count data or other activity data. The following attribute data may be used in the context of, for example, a sports game, an adventure game, a combat or war game, a racing game, etc.

Speed is an attribute having applicability to a wide range of video games to control the performance and/or behavior of an avatar in the context of the video game. One method of computing a speed attribute from step count data includes determining a speed value based on the maximum achieved step count during a specified window of time (e.g., a week), which may have a default value and/or may be specified by the application requesting the attribute data. According to some embodiments, a speed attribute may be determined based on the maximum step count achieved during a specified window relative to a reference or target step count (e.g., as a percentage of the reference or target steps). As with the window of time, the reference step count may default to a given value and/or the application seeking attribute data may provide the reference number of steps to customize the speed attribute for the application, making it more or less difficult to increase the speed of the associated avatar. The table below illustrates an example of computing a speed attribute from step count activity data, in accordance with some embodiments.

Ref/Target Steps 10000

| Window | Day 1 | Day 2 | Day 3 | Day 4 | Day 5 | Day 6 | Day 7 |
|---|---|---|---|---|---|---|---|
| Actual Steps | 7500 | 8750 | 9000 | 8900 | 9700 | 6000 | 7000 |
| Ratio (Ref/Actual) | 0.75 | 0.875 | 0.9 | 0.89 | 0.97 | 0.6 | 0.7 |
| Maximum | .97 | | | | | | |
| Speed % | 97 | | | | | | |

In the above example, the reference/target steps are set to 10,000 steps and a window of a week, which may be default values or may have been specified by a particular application requesting the speed attribute based on a user's activity as captured by the user's step counter. In this instance, the user's step counter recorded a maximum number of steps on the 5^{th} day of the week long window of time (e.g., the previous seven days culminating in the most recent full day), providing a speed value of 97 as a percentage of the reference number of steps. By providing the speed attribute as a percentage of a specifiable reference value, an application can obtain a normalized and meaningful speed attribute that can be applied as a speed characteristic of an associated avatar. It should be appreciated that the window may be a rolling or sliding window so that the window encompasses the most recent n days, where n is the number of days specified for the window. It should be further appreciated that the unit of time in which the window of time is segmented or portioned need not be days and may, for example, represent the most recent n hours or some other desired interval of time, as the aspects are not limited in this respect. In addition, more than one unit of time may be specified over which activity data is evaluated to, for example, provide increased granularity in determining attribute data. According to some embodiments, a more refined speed attribute may be determined by considering the speed/pace of the steps over the unit of time that the window represents (e.g., hours, days, etc.). For example, the speed attribute determined as discussed above may be increased or decreased based on the average pace of the steps accumulated over the base unit of time over which activity data is evaluated within the window of time.

As another example attribute, strength may also be a widely applicable characteristic to a number of different video games or interactive online content to control or augment the performance and/or behavior of an avatar within the context of the game. One method of computing a strength attribute from step count data includes determining a strength value based on the average step count achieved during a specified window (e.g., a week). According to some embodiments, a strength attribute may be determined based on the average step count achieved during a specified window relative to a reference or target step count (e.g., as a percentage of the reference or target steps). As with speed, the window and reference step count may default to a given value and/or the application seeking attribute data may provide desired values for these parameters to customize the strength attribute for the application, making it more or less difficult to increase the strength of the associated avatar. The table below illustrates an example of computing a strength attribute from step count activity data, in accordance with some embodiments.

Ref/Target Steps 10000

| Window | Day 1 | Day 2 | Day 3 | Day 4 | Day 5 | Day 6 | Day 7 |
|---|---|---|---|---|---|---|---|
| Actual Steps | 7500 | 8750 | 9000 | 8900 | 9700 | 6000 | 7000 |
| Ratio (Ref/Actual) | 0.75 | 0.875 | 0.9 | 0.89 | 0.97 | 0.6 | 0.7 |
| Average | .81 | | | | | | |
| Strength % | 81 | | | | | | |

Refinements to the strength attribute may take into consideration smaller units of time than that corresponding to the reference or target. For example, bursts of increased intensity captured over a 15 minute interval may be used to boost the strength attribute, or periods of decreased intensity can be used to reduce the strength attribute accordingly. Another attribute that may be useful to a wide range of applications is accuracy. For example, accuracy may play a key role in the performance of an avatar in a variety of video games where skill is relevant to game play. One method of determining accuracy is to assess not only the quantity of a user's activity, but a user's consistency as well. According to some embodiments, an accuracy attribute is determined based on the variance of the activity data (e.g., step count) over a specified window of time. The table below illustrates computing an accuracy attribute by taking the difference between the average step count and the variance in the activity performed by the user of the unit of time within the specified window.

Ref/Target Steps 10000

| Window | Day 1 | Day 2 | Day 3 | Day 4 | Day 5 | Day 6 | Day 7 |
|---|---|---|---|---|---|---|---|
| Actual Steps | 10000 | 10000 | 10000 | 10000 | 10000 | 10000 | 10000 |
| Ratio (Ref/Actual) | 1.0 | 1.0 | 1.0 | 1.0 | 1.0 | 1.0 | 1.0 |
| Variance of Ratios | 0.0 | | | | | | |
| Average | 1.0 | | | | | | |
| Average- | 1.0 | | | | | | |
| Variance | | | | | | | |
| Accuracy % | 100 | | | | | | |

In the above example, the user met the specified target for each of the seven days in the specified window. The quantity and consistency of the user's step count over the specified window of time resulted in a high accuracy value. The table below illustrates the impact on the accuracy attribute as a result of inconsistency in a user's activity over the specified window of time.

Ref/Target Steps 10000

| Window | Day 1 | Day 2 | Day 3 | Day 4 | Day 5 | Day 6 | Day 7 |
|---|---|---|---|---|---|---|---|
| Actual Steps | 4000 | 10000 | 6000 | 7000 | 10000 | 8000 | 4500 |
| Ratio (Ref/Actual) | 0.4 | 1.0 | 0.6 | 0.7 | 1.0 | 0.8 | 0.45 |
| Variance of Ratios | 0.06 | | | | | | |
| Average | .71 | | | | | | |
| Average- | .66 | | | | | | |
| Variance | | | | | | | |
| Accuracy % | 66 | | | | | | |

This technique in determining accuracy penalizes a user for inconsistent activity. Increasing activity later on in the interval to make up for days of lesser activity has less an impact on the accuracy attribute than consistently engaging in activity. Thus, the accuracy attribute favors a user of an activity tracking device that regularly and consistently engages in a high level of activity. The table below illustrates another instance of determining a value for an accuracy attribute using this same technique, in accordance with some embodiments.

Ref/Target Steps 10000

| Window | Day 1 | Day 2 | Day 3 | Day 4 | Day 5 | Day 6 | Day 7 |
|---|---|---|---|---|---|---|---|
| Actual Steps | 7500 | 8750 | 9000 | 8900 | 7000 | 6000 | 9700 |
| Ratio (Ref/Actual) | 0.75 | 0.875 | 0.9 | 0.89 | 0.7 | 0.6 | 0.97 |
| Variance of Ratios | 0.014 | | | | | | |
| Average | 0.81 | | | | | | |
| Average- | .79 | | | | | | |
| Variance | | | | | | | |
| Accuracy % | 79 | | | | | | |

The high level of consistency results in a high accuracy attribute, relative to the previous example where the user was less consistent in engaging in activity recorded by the user's activity tracking device. Finer granularity can be achieve by considering whether a user has periods of consistently high intensity activity, which can be used to boost the value of the accuracy attribute. Another exemplary attribute having applicability to a number of video games is endurance, which can be used to degrade or maintain other attributes during the course of playing a video game consistent with the endurance attribute. For example, a basketball player avatar may have high accuracy or speed values during the first half of a game, but a low endurance attribute may cause the speed and/or accuracy values to degrade sharply in the second half or in correspondence to the playing time of the avatar. Thus, to achieve a high level of performance of an avatar, the endurance attribute should be built up. According to some embodiments, activity towards the end of a specified window is biased to increase or decrease an endurance attribute accordingly. According to some embodiments, an endurance attribute is determined based on the total quantity of activity accumulated over a specified window of time. Accordingly, continued and frequent activity can translate into higher endurance values for an avatar, rewarding a user for high levels of regular activity.

It should be appreciated that the above examples are merely exemplary and attribute data for any desired attribute may be computed in any suitable way. In addition, attribute data may be determined from activity data from different types of activity tracking devices in different ways. Moreover, it should be appreciated that the above techniques are applicable to determining other types of data from activity data, such as access data to control access to and limit the duration of time for which a user is allowed to engage with electronic and/or online activities. The above described techniques can be applied to activity data provided from different types of activity tracking devices to determine different types of data (e.g., attribute data, access control data, activity points or capital, etc.).

In embodiments in which attribute data (or other types of data) is determined relative to a reference or target value, the reference or target value specified (or a default reference value used) may depend on the type of activity. In accordance with some embodiments, the reference or target value is generic to the type of activity. For example, an activity management server may handle the necessary conversions, translations and/or scaling necessary to provide attribute data relative to a reference value that merely specifies degree and is independent of the type of activity data. In particular, an application requesting attribute data may specify a reference value that, instead of specifying an amount of any particular activity (e.g., number of steps, calories burned, distance achieved, etc.), indicates an amount of activity generically to control the impact activity has on the attribute data. For example, a value between 0 and 1 may be provided to the activity management server as a reference value to dictate the degree to which the amount of activity data, from whatever source, should impact the attribute data.

In this manner, the application need know nothing about the underlying activity or activities used to compute attribute data. The activity management server may be configured to receive the generic reference value (e.g., a value between 0 and 1) and convert the generic reference value into one or more internal reference values having units corresponding to specific types of activities in order to determine corresponding attribute data. According to some embodiments, all accumulated activity data may be utilized in computing attribute data (e.g., when no window is specified, all available activity data may be used to compute attribute data).

As another non-limiting example, activity data may be used to influence aspects of games in other respects. For example, in strategy games such as chess, word games or other timed strategy games, activity data may provide additional time to make a move or provide other advantages to improve the user's performance in the game. Activity data may be used to unlock certain features or gain access to other benefits within the context of the game, thus translating real world activity into benefits or advantages during game play.

It should be appreciated that attribute data for use in influencing game play may be derived from accumulated activity data (i.e., activity data from activity engaged in prior to game play) and/or from activity data obtained from real-time or substantially real-time activity engaged in by the user during game play. For example, an activity tracking device may monitor one or more physiological parameters indicative of the user's emotional state and this data can be used to influence game play. For example, a heart rate monitor may provide activity data reflecting whether the player is remaining calm and in control or whether the user is operating in excited, frustrated or other elevated states. A player that can remain calm and under control may be rewarded with improved performance of one or more avatars under the user's control. Real-time activity data may be used in other ways, as the aspects are not limited in this respect. For example, to the extent that a user can engage in physical activity during game play, this activity data may be used to provide attribute data for influencing the behavior or performance of the one or more avatars in the game currently being played.

According to some embodiments, a video game operating using attribute data can be played individually or as a multiplayer video game, either with multiple players using the same game device, or with multiple players using different game devices (e.g., a multiplayer game engaged in by players connected via a network), wherein each player has a corresponding avatar (which can be fixed or changed over the course of the game) whose behavior or performance is governed or influenced by the respective user's real world activity as captured by the user's activity tracking device(s). In this way, a user's real world activity can contribute to how effective or valuable the respective user's avatars are in the context of a multiplayer game and, in this respect, may further incentivize users to engage in activities that increase their effectiveness in engaging with other users in game play. Whether in single player or multi-player contexts, linking real world activity of a user to game play may encourage a user to engage in healthy activities to boost avatar performance or otherwise improve gaming experience.

Enabling interactive entertainment with the ability to utilize a user's activity data to influence one or more avatars can also provide a measure of parental control over the interactive entertainment. For example, if a user does not engage in real world activity monitored by one or more activity tracking devices, the game play may become unenjoyable due to unsatisfactory performance of the corresponding avatar(s), and users may cease to engage with the interactive entertainment as a consequence. Thus, techniques of influencing avatars based on activity data may create self-regulating behavior because the enjoyment of the interactive entertainment is dependent on the amount of real world activity in which the user engages. Thus, significant levels of control may be imposed without having to actually limit use or access to the interactive entertainment, particularly in circumstances where a parent demands that interactive entertainment (e.g., video games) given to their children or that children are allowed to engage in be enabled with technology where game play is impacted by the real world activity of the child. Additional techniques of parental control according to other embodiments are discussed in further detail below.

As discussed above, too much or excessive time spent in certain electronic activities (e.g., engaging in interactive entertainment or other online activities) is a problem for many with no easy or compelling solution. For example, parents may want to limit the amount of time their children engage in electronic and/or online activity due to concerns of excessive screen time and/or concerns that such activities are replacing, or used to the exclusion of, healthier activity. However, conventional ways of limiting these activities, such as outright bans (which may not be desirable), or designating allowable times (which are difficult to manage and enforce), are generally unsatisfactory. The inventors have developed techniques for using activity data to control or otherwise limit a user's time spent engaged in, for example, playing video games, visiting online websites (e.g., social media websites) or other online activities (e.g., texting, emailing, etc.). For example, activity data captured by one or more activity tracking devices resulting from activity engaged in by a user may be converted into access to restricted activities. A restricted activity refers to any activity, typically those that are engaged in via one or more electronic or computing devices (electronic activities) and/or those that employ online connectivity (online activities), for which access is restricted or otherwise controlled based on the real world activity of the user captured by one or more activity tracking devices.

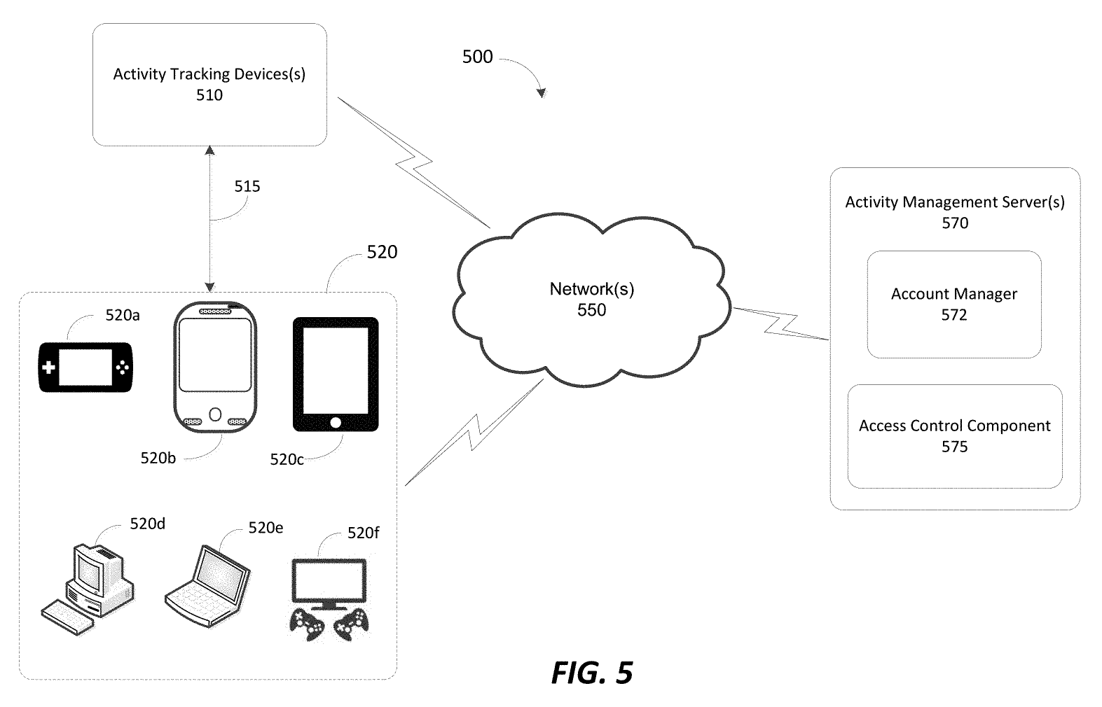

FIG. 5 illustrates a system providing access control to restricted activities, in accordance with some embodiments. System 500 may be similar to, and may be implemented as, systems described above in connection with FIGS. 1-3. For example, system 500 may be implemented as a cloud-based system comprising activity tracking device(s) 510 and an activity management server 570 connected to network 550 to receive activity data captured by activity tracking device(s) 510, either directly via network 550 or via one or more servers (e.g., third party servers associated with respective activity tracking device(s) 510). System 500 may be implemented in any of the ways described above and may perform any one or combination of activity services or techniques described herein. As with the systems illustrated in FIGS. 2 and 3, activity management server 570 may manage user accounts and associated profiles via account manager 572. Also connected to network 550 are computing devices 520, which may be of any type and number, configured to allow a user to engage in one or more restricted electronic and/or online activities (e.g., interactive entertainment such as playing video games, accessing online content such as social media, viewing online videos or browsing, texting, emailing, or otherwise utilizing network connectivity).

Activity management server 570 further comprises access control component 575 configured to generate access control data based on activity data for respective users received from activity tracking device(s) 510. Access control component 575 may use the activity data representing activity engaged in by the respective user to determine if, or for how long, the user should be entitled to engage in restricted activity based on the type, quantity, quality, consistency and/or recentness of activity engaged in by the user as captured by one or more activity tracking devices 510 associated with the user.

As one non-limiting example, access control component 575 may derive a duration, or data indicative of an amount of time, proportional to the quantity of activity data accumulated by a user by one or more activity tracking devices. However, access control data may be derived from activity data in other ways, as the aspects are not limited in this respect. It should be appreciated that access control component 575 too may be implemented as an API or in any other suitable way so as to service requests for access control data, and may be implemented as a network accessible service, implemented on one or more of computing devices 520 and/or integrated with application(s) executing thereon. Computing device(s) 520, or applications accessed via computing devices(s) 520, may utilize access control data provided by activity management server 570 to allow access to restricted activity to permit access proportionately to the amount of real world activity engaged in by the user.

As one example, when a user attempts to engage in a restricted activity, for example, use a restricted application having access control, the application may query activity management server 570 to verify that the user has sufficient activity data to access the restricted application and, if so, how long the user is allowed to continue engaging with the restricted application. The amount of time that the user has to continue engaging with the restricted activity may be displayed to the user via the computing device, for example, as a countdown timer, a meter icon, etc. When the user's time has expired, or the user disengages with the restricted activity, the computing device may communicate with the activity management server 570 to indicate how long the user engaged with the restricted activity so that the activity data, or measures derived therefrom, available to enable access can be decreased accordingly. Alternatively, the restricted application may decrement the access control data and communicate the remaining amount of access, if any, that the user retains after engaging with the restricted activity.

According to some embodiments, activity management server 570 may manage received activity data separately for different applications so that, if so desired, activity data can be utilized for a given purpose without impacting the ability to utilize the activity data for others. For example, the use of activity data for access control may be managed separately from the use of activity data for generating attribute data. In this manner, activity data can be exhausted by engaging in restricted activity without impacting the user's ability to use accumulated activity data in influencing behavior of avatars in the context of game play, or utilizing the activity data in other ways (e.g., as capital or points for discounts, as discussed in further detail below). However, managing activity data independently among different activity services is not a requirement and, in some embodiments, using activity data to gain access to restricted activities may also impact attribute data and vice versa.

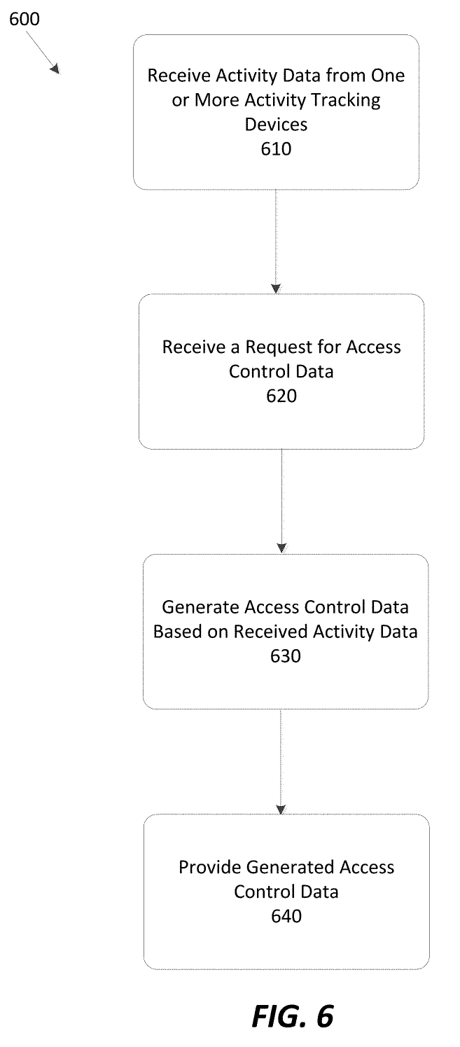

FIG. 6 illustrates a method of restricting and/or limiting access to restricted activities using activity data captured by one or more activity tracking devices monitoring the activity of a user, in accordance with some embodiments. Method 600 may be performed, for example, by the exemplary system illustrated in FIG. 5, or by any other suitable system. Act 610 may be similar in many respect to act 410 discussed in connection with method 400 depicted in FIG. 4. In particular, in act 610, activity data corresponding to activity engaged in by a user is obtained from one or more activity tracking devices coupled to the user to monitor the user's activity. It should be appreciated that any type of activity data from any number of activity tracking devices may be obtained including, but not limited to, the exemplary activity tracking devices and associated activity data described in the foregoing.

In act 620, a request for access control data is received. For example, a user may attempt to engage with a restricted activity by launching a video game application, opening a web browser, downloading, streaming or otherwise accessing online content, opening a texting or email client, accessing a social networking website, or initiating engagement with any other restricted activity. In response, a query may be sent to obtain access control data to assess whether the user should be allowed to engage in the restricted activity and, if so, for how long. For example, prior to allowing a user to play a video game, the video game application (or some associated application or component) may query an access control component, implemented locally on the video game device or accessible via a network, to assess whether the user has sufficient activity data accumulated and available to allow the user to play the video game and, if so, determine how long the user is authorized to play the video game. As another example, when a user attempts to access a restricted website, or more generally to access the internet via a browser, the browser may first confirm that the user has engaged in sufficient real world activity to allow the user to access the website or connect to the Internet. Texting and email applications can be restricted in a similar manner. In fact, access to virtually any electronic and/or online activity may be restricted or limited in this respect.

In act 630, access control data is generated in response to receiving the request by translating available activity into a measure of entitlement to access a restricted activity. For example, available activity data may be translated into a measure indicative of the duration or interval of time that the user can access the restricted activity, or the activity data may be translated into access points indicative of the amount of real world activity accumulated by the user. The access control data may include other information, as aspects of providing access control are not limited in this respect. According to some embodiments, the translation from activity data to access control data may vary in accordance with the type of restricted activity. For example, the same activity data may translate into less access time to a video game than to a social media website. As another example, activity data may translate into less access time for a violent first-person shooter video game than a strategy video game. In this way, more real world activity may be required to engage in certain restricted activities (e.g., those deemed more deleterious) than for others (e.g., texting, emailing, or general online browsing or connectivity). According to some embodiments, translation from activity data to access control data is independent of the requesting activity, and the requesting activity can determine access time based on the received access control data.

In either case, an authorized individual (e.g., a parent) may set preferences or customize how much access should be given to a user for respective restricted activities relative to the amount of accumulated activity data. For example, an authorized individual may be presented with an interface with controls (e.g., sliders, radio button, etc.) so that the authorized individual can set the level of restriction desired for respective restricted activities, or categories of restricted activities. For example, a restricted application may provide a mechanism by which an authorized individual can set the level of restriction desired for that particular application, ranging from highly restrictive to no restriction at all. The restriction level may then govern how received access control data is transformed into access time for the respective restricted activity. As another example, an authorized individual may set access restriction levels via an activity management server. For example, an authorized individual may have access to certain user's accounts (e.g., a parent may have access to their children's accounts via accounts of their own) that permit the authorized individual to set restriction levels for different categories of restricted activities and/or to set restriction levels for any restricted activity registered or otherwise linked to those user's accounts. In this way, customized restriction levels can be used to govern how activity data is translated to access control data according to the preferences of the authorized individual. It should be appreciated that access control and/or the customization of corresponding restriction levels may be realized in other ways, as access control based on activity data from one or more activity tracking devices is not limited for use to any particular implementation. It should be appreciated that some implementations may not allow for customization of the level of restriction provided, which may be fixed by the restricted activity and/or by an access control component.

Using the techniques described above, access to restricted activities can be controlled in a more satisfactory manner. Users (e.g., dependents) may be given control over their access to restricted activity, limited only by their willingness to engage in real world activity in exchange. By using access to restricted activity as a reward for healthy real world activity, users may be motivated to engage in healthy activities and empowered to engage in them more often. Parents, on the other hand, can be relieved of having to enforce arbitrary limits on access to restricted activities and can enjoy a measure of comfort knowing that whatever restricted activity their children (or other dependents or charges) are engaging in are balanced by a proportionate amount of healthy activity.

As discussed above, an activity tracking system, such as the exemplary system illustrated in FIG. 2, may include a cloud-based platform by which activity management services are provided by an activity management server (which may include multiple servers, including third-party servers associated with respective activity tracking devices and/or one or more servers independent of the activity tracking devices). Users can create, develop and customize accounts with the activity management platform and can link to other accounts and share information using bi-lateral techniques (e.g., using invite and accept techniques), using unilateral techniques (e.g., by “following” other users), or using many-to-one techniques (e.g., by allowing users to join groups of interest), etc. These techniques of linking or otherwise associating user's activity accounts facilitates sharing, and also allows for techniques involving aggregating group activity data for use in discounts or other monetary benefits.

For example, an organization, such as a company or other enterprise, may establish a group that its members (e.g., employees) can join. The activity management service can aggregate activity data of the members of the group to achieving one or more objectives of the group. For example, the activity management service may translate the activity data of individual members into aggregate activity points or capital indicative of general health or fitness of the group. As one example application for group health or fitness metrics, health insurance companies may offer discounted premiums for companies that achieve designated health and fitness levels based on the company's aggregate activity data. This may in turn incentivize companies to subsidize employee's gym memberships and/or offer other fitness opportunities to its employees, such as providing free (or reduced rates) fitness classes, organize fitness opportunities such as company walks or races, etc. In this way, group participation in healthy activity can be encourage and incentivized.

Group activity data may be used in other respects to encourage or incentivize group members to continue to engage in healthy real world activity, as the aspects are not limited in this respect. As one example, organizations may compete with each other for monetary benefits or for charity purposes. For example, a sponsor organization may offer to donate to a charity in proportion to aggregate activity data of participating companies (or groups that are otherwise affiliated or related such as interest groups, for example) over a designated period of time and/or may offer to donate a certain amount on behalf of the group having the highest activity count at the end of the designated period. In this way, group activity data and individual contributions thereto can be used in a charitable way.

As discussed above, a user's activity profile can be utilized in the context of online virtual or simulated competitions between teams based on their activity profiles. For example, users may be drafted or otherwise invited to join a team (or a user can draft, invite or recruit other users to join a team) in a simulated competition where the users' activity profiles compete against one another in the simulated competition. The amount of activity engaged in the by the user then corresponds to how well the user will perform in the simulated competition, and the user's value or worth in this respect has a corresponding connection to the user's real world activity. A non-limiting example use is in the context of multi-player video games wherein users can build a team to compete against another team. Users may be charged (e.g., in the form of real money or in the form of credits, rewards or discounts) in exchange for the privilege of having another user join a team, so that users are in some sense drafted based on their activity profiles. Thus, a user's activity profile can be used as a commodity and a user's real world activity can be monetized.

According to some embodiments, an activity management component can set the “price” associated having a particular user join a team based on, for example, one or more any combination of an assessment of the user's activity worth based on evaluating the user's activity data, the number of teams the user has joined, past performance in other games, or any other factor real or virtual that increases the user's marketplace value in this respect. Alternatively, or in some cases in addition to, users can set their “prices” (whether monetary or in the form of other benefits), which may correspond to how much activity capital or activity points the user has accrued or based on other measures that may impact the user's desirability for a team, including celebrity, number of other users that have drafted the user, etc. Thus, users' activity profiles may be capitalized in this respect, providing further incentives to engage in healthy activity.

According to some embodiments, a virtual agent is employed on users' behalf to recommend other users for particular interactive entertainment and/or to recommend interactive entertainment or other applications in which the user may be interested in engaging or participating. For example, a given user may want to participate in a particular activity and the virtual agent may evaluate user profiles and recommend other users to the given user that the user may want to connect with to potentially join in the interactive entertainment, either as a teammate or as a competitor, based on any number of factors including users' past involvement and/or performance in the interactive entertainment, activity data statistics and/or other aspects of users' performance or profiles (e.g., demographic or geographic similarity to the given user, or some other connection or relationship captured by the respective activity profiles) that suggest a recommendation. The virtual agent may also recommend to a given user interactive entertainment or other applications that utilize the user's activity profile, making the user aware of uses by which the user can enjoy or otherwise exploit their activity. Such recommendations may be based on the popularity (e.g., as measure of the number of users participating, user ratings, etc.) of the corresponding application, recommendations from users that are either linked to the given user or are similarly situated in other respects, or based on other factors such as promotions by the vendor of the application, etc. Thus, virtual agents may be utilized to increase the value of an activity account to the user so that the user can get the most out of the real world activity in which the user engages.

It should be appreciated that any one or combination of aspects, techniques and/or features of an activity management component (e.g., service, server, platform, integrated functionality, etc.) described herein may be used alone or in any combination to provide an activity management solution, as these techniques are not limited for use to the specific combinations described.

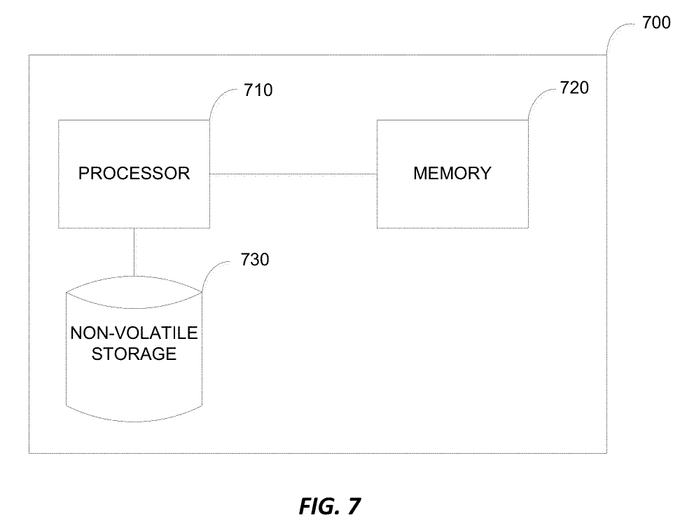

An illustrative implementation of a computer system 700 that may be used to implement one or more techniques described herein is shown in FIG. 7. Computer system 700 may include one or more processors 710 and one or more non-transitory computer-readable storage media (e.g., memory 720 and one or more non-volatile storage media 730). The processor 710 may control writing data to and reading data from the memory 720 and the non-volatile storage device 730 in any suitable manner, as the aspects of the invention described herein are not limited in this respect. Processor 710, for example, may be a processor on an activity tracking device, mobile device, personal computing device, game device, client device, server device and/or any computing device accessible via a network (e.g., cloud accessible).

To perform functionality and/or techniques described herein, the processor 710 may execute one or more instructions stored in one or more computer-readable storage media (e.g., the memory 720, storage media, etc.), which may serve as non-transitory computer-readable storage media storing instructions for execution by processor 710. Computer system 700 may also include any other processor, controller or control unit needed to route data, perform computations, perform I/O functionality, etc. For example, computer system 700 may include any number and type of input functionality to receive data and/or may include any number and type of output functionality to provide data, and may include control apparatus to perform I/O functionality.

In connection with performing techniques described herein, one or more programs configured to receive information, process the information or otherwise execute functionality described herein may be stored on one or more computer-readable storage media of computer system 700. In particular, some techniques described herein may be implemented as instructions stored on one or more computer-readable storage media. Processor 710 may execute any one or combination of such programs that are available to the processor by being stored locally on computer system 700 or accessible over a network. Any other software, programs or instructions described herein may also be stored and executed by computer system 700. Computer system 700 may represent the computer system on a host device on which a virtual medical assistant application is installed and/or may represent the computer system on which any one or combination of network resources are implemented (e.g., any one or combination of components forming a virtual medical assistant, or other network resource). Computer system 700 may be implemented as a standalone computer, server, part of a distributed computing system, and may be connected to a network and capable of accessing resources over the network and/or communicate with one or more other computers connected to the network.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting.

What is claimed is:

1. An activity tracking system comprising:
at least one activity tracking device configured to track activity of a user and to generate activity data corresponding to an amount of the activity performed by the user; and
at least one server communicatively coupled to the at least one activity tracking device via a network to receive the activity data, the at least server configured to:
receive a request from a video game application for attribute data for an avatar of the video game application;
determine the attribute data including at least one attribute based on the activity data received from the at least one activity tracking device; and
provide the attribute data to the video game application to influence at least one aspect of the avatar during game play of the video game application.

2. The activity tracking system of claim 1, wherein the at least one activity tracking device includes an device capable of counting steps of the user, determining an amount of locomotion by the user and/or determining a distance covered by the user.

3. The activity tracking system of claim 1, wherein the at least one server determines a speed attribute, an accuracy attribute, a strength attribute and/or an endurance attribute for the avatar in response to receiving the request for attribute data.

4. The activity tracking system of claim 3, wherein the at least one server receives a request that includes a reference value relative to which the attribute data is determined.

5. The activity tracking system of claim 4, wherein the at least one server receives a request that indicates a window of time over which activity data may be used to determine the attribute data.

6. The activity tracking system of claim 5, wherein the at least one server receives a request that indicates a unit of time in which the window of time is segmented over, and wherein activity data is evaluated over each unit of time within the window of time.

7. The activity tracking system of claim 6, wherein the at least one server determines a ratio for each unit of time within the window of time, each respective ratio being determined based on the amount of activity performed by the user during each respective unit of time within the window of time relative to the reference value.

8. The activity tracking system of claim 7, wherein the at least one server determines the attribute data based, at least in part, on the determined ratios.

9. The activity tracking system of claim 1, wherein the at least one server manages an activity account for the user to which one or more activity tracking devices can be linked to enable respective activity data to be obtained.

10. The activity tracking system of claim 9, wherein the activity account can be linked to one or more applications to which attribute data can be provided.

11. An activity tracking system comprising:
at least one activity tracking device configured to track activity of a user and to provide activity data corresponding to an amount of the activity performed by the user; and
at least one server communicatively coupled to the at least one activity tracking device via a network to receive the activity data, the at least server configured to:
receive a request for access data in connection with an electronic and/or online activity;
determine the access data based on the activity data received from the at least one activity tracking device; and
provide the access data to allow and/or control access to the electronic and/or online activity.

12. The activity tracking system of claim 11, wherein the at least one server determines access data that includes a duration of time that the user can engage with the electronic and/or online activity.

13. The activity tracking system of claim 12, wherein the at least one server is configured to receive an indication of an amount of elapsed time in which the user was engaged with the electronic and/or online activity.

14. The activity tracking system of claim 13, wherein the at least one server is configured to decrement the access data based on the received amount of elapsed time.

15. The activity tracking system of claim 13, wherein the at least one server is configured to decrement the activity data available for use in determining access data based on the received amount of elapsed time.

16. The activity tracking system of claim 11, wherein the at least one server manages an activity account for the user to which one or more activity tracking devices can be linked to enable respective activity data to be obtained.

17. The activity tracking system of claim 16, wherein the activity account can be linked to one or more electronic and/or online activities to which access data can be provided.

18. The activity tracking system of claim 17, wherein the activity account comprises access control settings configurable to allow an authorized individual to configured the access control settings for the one or more linked electronic and/or online activities linked to the activity account.

19. The activity tracking system of claim 18, wherein the activity account is configured to allow the authorized individual to control a degree to which the at least one server determines access data from activity data for each of the electronic and/or online activities linked to the activity account.

20. The activity tracking system of claim 18, wherein the activity account is configured to allow the authorized individual to specify which of the one or more activity tracking devices linked to the activity account can contribute to determining access data.
